(19) United States
(12) Patent Application Publication
(10) Pub. No.: US 2012/0327407 A1
(43) Pub. Date: Dec. 27, 2012

(54) Independent Component Analysis of Surface-Enhanced Raman Scattering (SERS) Signals

(75) Inventors: Yiping Zhao, Statham, GA (US); Qun Zhao, Watkinsville, GA (US); Justin L. Abell, Athens, GA (US); Joonsang Lee, Athens, GA (US)

(73) Assignee: University of Georgia Research Foundation, Inc., Athens, GA (US)

(21) Appl. No.: 13/528,075

(22) Filed: Jun. 20, 2012

Related U.S. Application Data
(60) Provisional application No. 61/499,313, filed on Jun. 21, 2011.

(51) Int. Cl. G01J 3/44

(52) U.S. Cl. 356/301

(57) ABSTRACT

Embodiments of the present disclosure, in one aspect, relate to methods of analyzing SERS signals, systems for analyzing SERS signals, in particular, using an independent component analysis, and the like.

### CROSS-REFERENCE TO RELATED APPLICATION

This application claims priority to U.S. provisional application entitled “INDEPENDENT COMPONENT ANALYSIS OF SURFACE-ENHANCED RAMAN SCATTERING (SERS) SIGNALS,” having Ser. No. 61/499,313, filed on Jun. 21, 2011, which is entirely incorporated herein by reference.

### STATEMENT REGARDING FEDERALLY SPONSORED RESEARCH OR DEVELOPMENT

This invention(s) was made with government support under Grant No.: 2009-35603-05001, awarded by the USDA. The government has certain rights in the invention(s).

### BACKGROUND

Surface-enhanced Raman spectroscopy (SERS) has attracted a great deal of attention due to its powerful merits as ultra-sensitive, label-free trace chemical sensing platform. The ability of SER spectra to provide sharp, highly resolved spectral finger-prints has allowed for superior chemical and biological sensing. However, obtaining information about individual analyte(s) the within a SERS spectra is a very challenging task for samples having complex mixtures.

### SUMMARY

Embodiments of the present disclosure, in one aspect, relate to methods of analyzing SERS signals, systems for analyzing SERS signals, in particular, using an independent component analysis, and the like.

An exemplary embodiment of the present disclosure includes, among others, a method of analyzing a SERS signal that includes: acquiring SERS data from a sample, performing an independent component analysis on the SERS data, and determining one or more analytes present in the sample.

An exemplary embodiment of the present disclosure includes, among others, a method of analyzing a SERS signal that includes: disposing the sample on a SERS structure and generating a composition gradient along the x-axis, the y-axis, the diagonal axis, or a combination thereof, acquiring SERS data from a plurality of positions of the composition gradient, and determining the ratio of one or more pairs of analysts at each of the multiple distinct areas.

An exemplary embodiment of the present disclosure includes, among others, a method of analyzing a SERS signal that includes: disposing the sample on a SERS structure and generating a composition gradient along the x-axis, the y-axis, the diagonal axis, or a combination thereof, acquiring SERS data from a plurality of positions of the composition gradient, performing an independent component analysis on the SERS data acquired from the plurality of positions along the composition gradient, comparing the SERS data obtained from the multiple distinct areas of the SERS structure, and determining the ratio of one or more pairs of analysts at each of the multiple distinct areas.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1.1A illustrates a diagram of the mixed BPE and MPh droplet spreading on the AgNR substrate and the possible spatial distribution of the resulting films of analyte BPE and MPh. The approximate locations P1 through P9 are labelled here as a reference. FIG. 1B illustrates the average SERS spectra for methanol, BPE, MPh, and 1:1 BPE:MPh mixture. The artificially summed SERS spectrum of MPh and BPE and the SERS spectra of the mixture sample at different substrate location are also shown.

FIG. 1.2 illustrates a comparison of the measured spectra (solid) and ICA-calculated spectra (dashed) for (A) BPE and (B) MPh SERS.

FIG. 1.3 illustrates plots of the normalized weighting coefficients and normalized SERS intensity for BPE (FIG. 1.3A) and MPh (FIG. 1.3B). Each figure shows three plots: i) the normalized ratio of a₂ⱼ with respect to a₁ⱼ, where 1 and 2 represent the weighting coefficient calculated for the reference point (P1, edge of substrate) and some other location, respectively, and j=1 or 2 for BPE and MPh, respectively; ii) same as i) but using P5 (center of substrate) as the reference location; and iii) the normalized intensity of I₁₂₀₀ (BPE) and I₁₀₇₆ (MPh). For i) and ii) the a₂ⱼ/a₁ⱼ ratio is normalized to the maximum ratio value obtained. Note that the weighting coefficient values for the location P1 or P5 assumed to be the same value (a₁₁=a₂₁ and a₁₂=a₂₂) when these locations are used as reference.

FIG. 2.1 illustrates the comparison of the measured spectra (solid) and ICA-estimated spectra (dashed) for (A) BPE and (B) MPh SERS at P5 using P1 as a reference.

FIG. 2.2 illustrates a plot of the normalized weighting coefficients and normalized SERS intensity for A) BPE and B) MPh. Each figure shows three plots: i) the normalized ratio of a₂ⱼ/a₁ⱼ, where 1 and 2 represent the weighting coefficient estimated for the reference point (P1, edge of substrate) and some other location, respectively, and j=1 or 2 for BPE and MPh, respectively; ii) same as i) but using P5 (center of substrate) as the reference location; and iii) the intensity of I₁₂₀₀ (BPE) and I₁₀₇₆ (MPh) normalized to the highest value. For i) and ii) the a₂ⱼ/a₁ⱼ ratio is normalized to the maximum ratio value obtained.

FIG. 2.3 illustrates the calculated BPE:MPh ratio using the a₂₁/a₂₂ calibration curve in FIG. 2.8, and IBPE/IMPh calibration curve in FIG. 2.8.

FIG. 2.4 illustrates a graph showing the measured intensity of BPE and MPh as a function of their respective concentration ratios. Each data point is an average of multiple points (n=15) on a single substrate; the error bars represent one standard deviation.

FIG. 2.5 illustrates graphs that show the comparison of representative estimated spectra (solid line) of y₁ (left) and y₂ (right) compared to the pure source signal (dotted line) for different mixture ratios. Spectra were generated using the references x₁=50:50 BPE:MPh. The correlation coefficient r is presented for each plot. Scale is identical for all plots.

FIG. 2.6 illustrates the correlation coefficients r vs BPE:MPh mixture samples for A) y₁ vs. 100:0 BPE:MPh and B) y₂ vs. 0:100 BPE:MPh. Correlation coefficients were generated for y₁ and y₂ vs pure BPE and MPh samples using different x₁ reference samples: (!)—100:0, (,)—50:50, and (Ω)—0:100 BPE:MPh.

FIG. 2.7 illustrates graphs that show the comparison of the normalized a₂₁/a₁₁ ratio and the measured I_{BPE} as a function of BPE:MPh mixture ratio. The normalized a₂₁ and a₁₁ are obtain using different x₁ reference samples: (!)—100:0, (,)—50:50, and (Ω)—0:100 BPE:MPh; I_{BPE} is represented with the (ξ). B) Same as (A) but using normalized a₂₂/a₁₂ and I_{MPh}.

FIG. 2.8 illustrates a calibration plot of a₂₁/a₂₂ versus BPE:MPh molar ratio. The weighting coefficients a₂₁ and a₂₂ were obtained from the 50:50 BPE:MPh reference data. The dotted line represents a linear fit of the data with its equation shown.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, biochemistry, biology, molecular biology, imaging, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### Definitions

In describing and claiming the disclosed subject matter, the following terminology will be used in accordance with the definitions set forth below.

The term “Surface-Enhanced Raman Scattering (SERS)” refers to the increase in Raman scattering exhibited by certain molecules in proximity to certain metal surfaces. (see, U.S. Pat. No. 5,567,628) The SERS effect can be enhanced through combination with the resonance Raman effect. The surface-enhanced Raman scattering effect is even more intense if the frequency of the excitation light is in resonance with a major absorption band of the molecule being illuminated. In short, a significant increase in the intensity of Raman light scattering can be observed when molecules are brought into close proximity to (but not necessarily in contact with) certain metal surfaces.

The term “detectable signal” is a SERS signal. The SERS signal is detectable and distinguishable from other background signals that are generated from sample. In other words, there is a measurable and statistically significant difference (e.g., a statistically significant difference is enough of a difference to distinguish among the detectable signal and the background, such as about 0.1%, 1%, 3%, 5%, 10%, 15%, 20%, 25%, 30%, or 40% or more difference between the acoustic detectable signal and the background) between detectable signal and the background. Standards and/or calibration curves can be used to determine the relative intensity of the detectable signal and/or the background.

The term “sample” can refer to a fluid sample. The sample may be taken from a subject. The fluid may be, but is not limited to, urine, buccal swabs, saliva, semen, blood, ascites, pleural fluid, spinal fluid, and the like.

As used herein, the term “subject” or “host” includes humans and mammals (e.g., mice, rats, pigs, cats, dogs, and horses,). Typical subjects to which compounds of the present disclosure may be administered will be mammals, particularly primates, especially humans. For veterinary applications, a wide variety of subjects will be suitable, e.g., livestock such as cattle, sheep, goats, cows, swine, and the like; poultry such as chickens, ducks, geese, turkeys, and the like; and domesticated animals particularly pets such as dogs and cats. For diagnostic or research applications, a wide variety of mammals will be suitable subjects, including rodents (e.g., mice, rats, hamsters), rabbits, primates, and swine such as inbred pigs and the like.

### Discussion

In accordance with the purpose(s) of the present disclosure, as embodied and broadly described herein, embodiments of the present disclosure, in one aspect, relate to methods of analyzing SERS signals, systems for analyzing SERS signals, in particular, using an independent component analysis, and the like.

SERS detection is traditionally limited to relatively pure samples, but mixture samples containing many compounds, e.g., blood, are more relevant to real-world applications of SERS. However, mixtures will typically produce complex spectra (containing spectral features from many compounds) making discrimination of the individual spectra within the mixture challenging. Independent component analysis (ICA) is an unsupervised statistical technique that has been previously been demonstrated to be capable of the discrimination of individual source signals within a biological sample (e.g., skin) for bulk Raman (i.e., non-SERS) detection.

Embodiments of the present disclosure elucidate a means to use ICA, in conjunction with an artificially generated 2-dimensional spatial analyte concentration gradient onto the surface of the AgNR SERS substrates. This allows discrimination and detection of the individual source spectra generated by each analyte species at concentrations well below the capabilities of bulk Raman analysis.

An embodiment of the present disclosure includes a method of analyzing a detectable SERS signal and a system for analyzing a detectable SERS signal. In general, the SERS signal can be acquired in one or a number of ways. In an embodiment, the SERS signal is acquired in a manner consistent with the discussion in the Examples.

In general, a sample from a subject is disposed (e.g., using a dropper or syringe) on a SERS substrate. The selection of the SERS substrate and any material disposed thereon can be determined based on the goals of the analysis, the sample type, the component type, and the like. In an embodiment, the sample is disposed at a single location and the sample spreads out from that location. In an embodiment, the sample flows across the SERS substrate out from the location of where the sample was disposed. In an embodiment, the components the sample may flow across and/or interact (e.g., hydrophobic interaction, hydrophilic interaction, hydrogen bonding, biological interactions, and the like) with the surface of the substrate, at different rates so a gradient of components (composition gradient) may be present on the SERS substrate as a function of position on the SERS substrate.

Subsequently, the SERS substrate (e.g., a plurality of distinct areas or locations (e.g., two to thousands or more) on the SERS substrate across (e.g., from end to end along the length, width, and/or diagonally)) is analyzed using a SERS system to acquire a SERS signal. In an embodiment, the SERS substrate is analyzed at varying distances from the point where the sample was disposed to examine the composition gradient. In an embodiment, the SERS signal may include one or more peaks corresponding to one or more components (analytes) in the sample as a function of position on the SERS substrate.

Once the SERS signal is acquired, the data from the SERS signal can be processed using an independent component analysis to distinguish the peaks of the one or more analytes. In an embodiment, ratios of the analytes (e.g., ratios of various pairs of analytes) can be generated from the different locations along the SERS substrate (e.g., the composition gradient). Once the data has been processed, the analysis may reveal that the sample includes one or more target analytes. Additional details regarding independent component analysis and embodiments of the present disclosure are provided in the Example.

### EXAMPLE

Now having described the embodiments of the present disclosure, in general, the example describes some additional embodiments of the present disclosure. While embodiments of the present disclosure are described in connection with the example and the corresponding text and figures, there is no intent to limit embodiments of the present disclosure to these descriptions. On the contrary, the intent is to cover all alternatives, modifications, and equivalents included within the spirit and scope of embodiments of the present disclosure.

### Example 1

### Brief Introduction

By generating a composition gradient on a highly uniform SERS substrate and applying independent component analysis, we demonstrate that one can extract the intrinsic SERS spectrum of individual components from SERS spectra obtained from a two-component mixture.

### Introduction

Surface-enhanced Raman spectroscopy (SERS) has attracted a great deal of attention due to its powerful merits as ultra-sensitive, label-free trace chemical sensing platform. The ability of SER spectra to provide sharp, highly resolved spectral finger-prints has allowed for superior chemical and biological sensing. Traditionally, SERS has been employed for analysis of relatively pure samples in a well defined medium; however, biologically-relevant samples, such as blood or sputum, contain a mixture of components, and the resulting SERS spectra can be very complicated compared to those of pure analytes. Obtaining information about individual analyte(s) within the within a SERS spectra is a very challenging yet very urgent task for the SERS community. So far, most reports in the literature use direct visual observation or statistical methods such as principle component analysis (PCA) to analyze SERS mixture signals.¹⁻⁶ However, to obtain information on individual components, a blind source separation method called independent component analysis (ICA) has been used.⁷

ICA is a stastical method that extracts individual source signals from the measured mixture signal. For example, if the mixtured signal comes from a mixture of two analytes with source signal sᵢ (i=1, 2), and the signal from the mixture, xᵢ(i=1, 2), can be expressed as a linear combination of s₁ and s₂,

xᵢ=aᵢⱼsᵢ+aᵢⱼsᵢ (1)

where aᵢⱼ (i, j=1, 2) is constant, representing the weighting factor of a particular source signal. The objective of ICA is to determine the source signals sᵢ and their respective mixing or weighting factors aᵢⱼ from a given measurement xᵢ under the constraint that the source signals are statistically independent. ICA has been used to discriminate source signals from biological mixture signals for bulk Raman measurements,⁸⁻¹² but to the best of our knowledge ICA has never been implemented with SERS.

In order to perform ICA, at least two signals each containing a different mixture ratio, are determined from at least two measurements x₁ and x₂. The measured mixture signal xᵢ is assumed to be a linear combination of source spectra s_{i.} produced by each species of analyte within the mixture, and the two source spectra have to be independent from each other. For real samples such as blood or sputum, the composition ratios of different analysts are fixed once the samples are received. Thus, it is challenge to obtain two SERS spectra from samples with different compositions. One approach to address this challenge is to utilize the intrinsic, nonuniform distribution of analyte molecules that results when a liquid mixture is applied to a SERS-active surface. The resulting distribution of analytes onto the sensing surface can be significantly affected by the analytes' diffusivity and adsorption capability, as well as the drying process of the sample solvent. Because the measured SERS signal is proportional to the number of molecules within the measurement area, the resulting spatial distribution of each species onto the surface can be mapped by acquiring multiple measurements at different points on the substrate. In this Example, we utilize the intrinsic sampling-induced nonuniform distribution of two different analytes within a mixture sample, couple with ICA, to demonstrate a proof-of-principle for unsupervised separation of SERS source spectra from measurements obtained from a mixture sample.

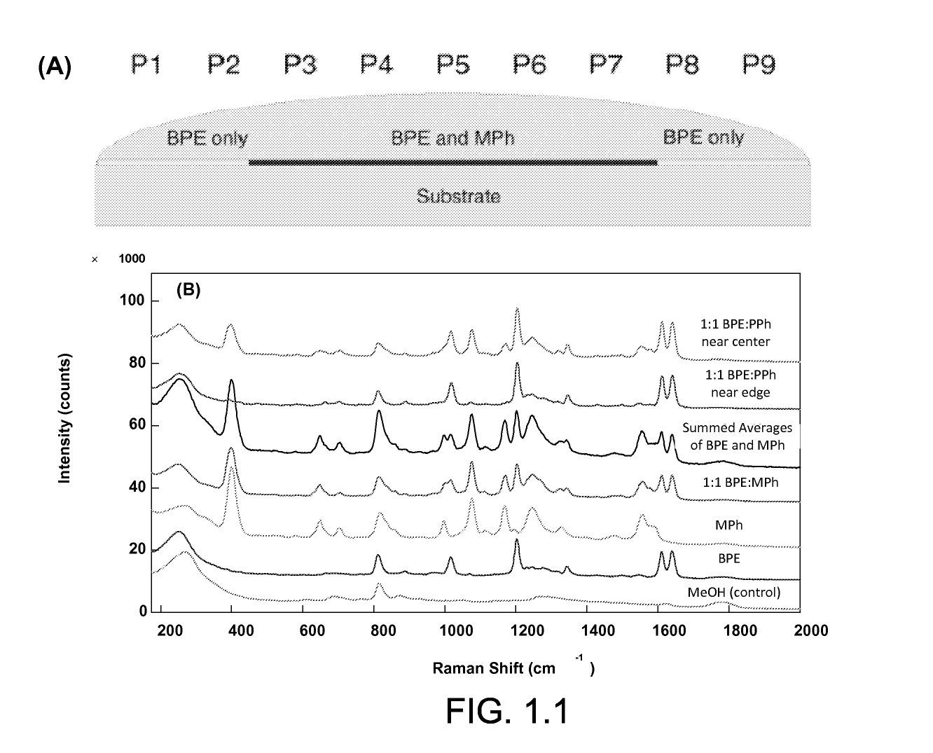

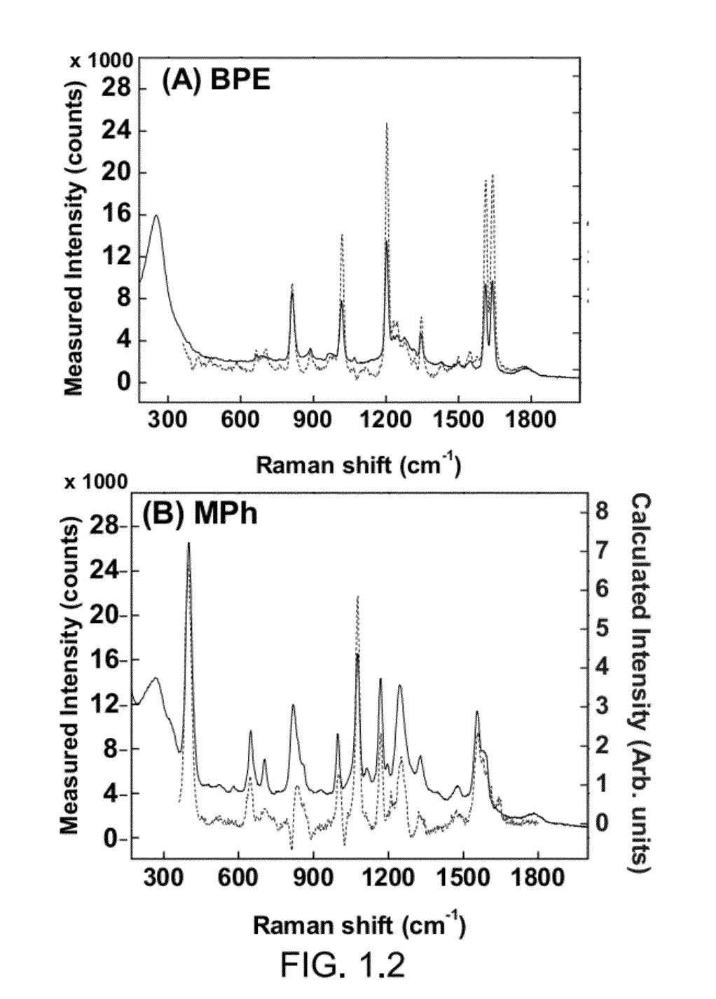

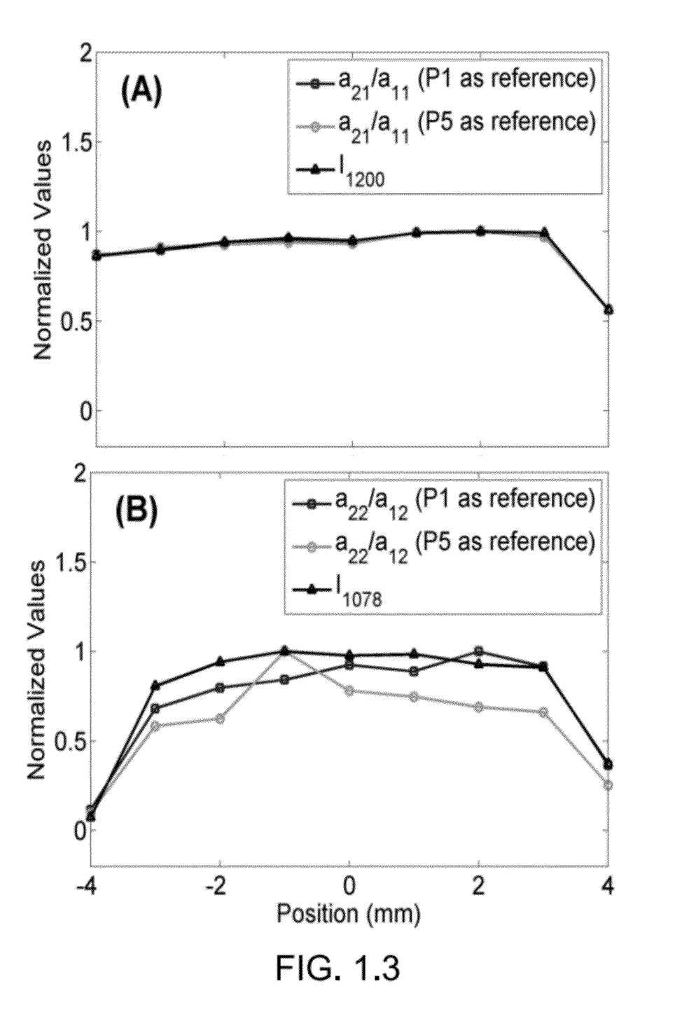

To demonstrate the principle, two analytes, trans-1,2-bis(4-pyridyl)ethylene (BPE) and 4-hydroxy thiophenol (i.e. mercaptophenol, MPh), are selected because they both produce strong yet distinct SERS spectra. Furthermore, BPE and MPh adsorb strongly to Ag or Au but through different chemical constituents, a lone-pair nitrogen and a thiol, respectively, and therefore are expected to adsorb to the surface at different rates and with different equilibrium constants. Thus, applying a droplet containing a mixture of these analytes to a SERS surface should simultaneously generate a non-uniform distribution of the two analytes with varying, and spatially-dependent surface coverage ratios after the sample solvent dries (FIG. 1.1A). Assuming that these two analytes are present at fairly low concentrations and allow for submonolayer coverage thus minimizing competition of the two analytes for adsorption sites, this approach should meet the aforementioned requirements.

BPE and MPh were dissolved in methanol to yield 5×10⁻⁵ mol L⁻¹ solutions. A mixture of 1:1 BPE:MPh, with each analyte present at 5×10⁻⁵ mol L⁻¹ was also prepared. The SERS measurements were performed by dispensing a 4 μl volume of the mixture at the center of a small 1×1 cm² silver nanorod (AgNR) SERS substrates.^{13, 14} The droplet immediately spread across the entire surface of the AgNR substrate and the methanol completely evaporated in ˜1 min.

SERS measurements were obtained using a portable Raman system (Enwave Optronics, model 10HT-HRC) with a λ=785 nm laser coupled to a fiber optic probe tip. All measurements were obtained using 30 mW of power with a 2 s integration time; the substrate was positioned using a microscope translation stage. Approximately 9 measurements were mapped along a line across the substrate using ˜1 mm steps as shown in FIG. 1.1A. This line mapping was performed for three lines across the top, center, and bottom of substrate.

FIG. 1.1B shows the SERS spectra of pure BPE, MPh, the 1:1 BPE:MPh mixture acquired from an average of 9 points measured in a grid-like pattern across the entire 1×1 cm² substrate. The figure also includes a representative spectrum of the MeOH as well as an artificial spectrum generated by summing the pure MPh and BPE spectra together. The measured BPE signal (s₁) demonstrates sixteen observable peaks at Δν=254, 691, 811, 888, 969, 1016, 1068, 1203, 1231, 1245, 1277, 1344, 1430, 1495, 1546, 1611, and 1640 cm⁻¹ with the primary BPE peaks being Δν=1016, 1203, 1611, and 1640 cm⁻¹, which correspond to the pyridine ring breathing, C═C ethylene stretch, C═C pyridine stretch, and C═C ethylene stretch, respectively.¹⁵ Fifteen peaks are distinguishable in the measured MPh spectrum (s₂), Δν=273, 330, 400, 582, 649, 704, 820, 996, 1076, 1115, 1169, 1250, 1342, 1482, and 1555 cm⁻¹. Of these, the primary peaks observed for MPh are Δν=400, 1076, and 1169 cm⁻¹, which corresponds to ring vibrations of the benzene constituent.¹⁶ BPE and MPh therefore appear to have fairly distinct spectra, with the only significantly overlapping peaks at Δν=1016 and 996 cm⁻¹. Furthermore, comparing these spectra to those acquired from the control sample (methanol only) we can see the large, defined peak at Δν=−800 cm⁻¹ common in all the spectra and likely due to the background signal resulting from adsorbed contaminants. The SERS spectrum of the BPE:MPh mixture is essentially identical to the artificial spectrum by adding the SERS spectra of pure BPE and pure MPh together, confirming that the SERS spectrum of a mixture is a linear combination of the individual SERS spectra of BPE and MPh. Finally, the similarity between the BPE and MPh spectra are quantitatively estimated by the spectral cross-correlation coefficient R, with R=−0.0046, which demonstrates the independence of SERS spectra of the two source analytes. Thus, we can apply ICA algorithm to the SERS spectra of the mixture.

Also, as expected, a large variation in SERS spectra at different locations of the mixture was obtained for MPh, indicating a non-homogenous distribution of the analyte onto the surface. The spectra of the BPE:MPh mixture acquired near the center (x_{P5}) and near the edge (x_{P1}) of the substrate are also presented in FIG. 1.1B. Cursory examination of these spectra show that the BPE peak intensities is relatively insensitive to positions, indicating a uniform BPE surface coverage across the SERS substrate; while the MPh peak intensities at Δν=400, 1076, 1169, and 1555 cm⁻¹ decrease significantly as the measurement position approaches the edge of the substrate. This indicates that the surface coverage of MPh decreases from center to edge, implying that there is a spatial gradient of the BPE and MPh on the substrate surface. This result is expected due to the capillary spreading of the droplet and the interfactial interaction nature of BPE and MPh. Since MPh adsorbs on the Ag surface with a much faster rate compared to that of BPE, and there are only very limit amount of each molecules in the solution, during the spreading of the mixture droplet, the MPh molecules will be depleted before the wetting front reaches the edge of the substrate. However, because BPE may be adsorbing more slowly on the AgNR, there would still be enough BPE molecules access (and adsorb) near wetting front before it is depleted. Therefore, a gradient of MPh and BPE coverage from the center to the edge will be established as shown in FIG. 1.1A. Such a spatial variation of the analyte intensity ratio is key to demonstrate the separation principle in this work. Finally, the spectral features resulting from the background show very little variation.

The mixture spectra, x_{P1} and x_{P5}, measured from the 1:1 BPE:MPh mixture at the edge and the center of the substrate (the top two spectra shown in FIG. 1.1B) were used as the mixture signals x₁ and x₂ to perform ICA analysis. We have employed FastICA which uses a fixed point algorithm and the negentropy as a cost function to estimate the original spectra.⁸ Whitening was performed as a preprocessing by transforming the observed vector x linearly so that its components are uncorrelated and their variances equal unity. The spectra were also truncated below 360 cm−1 to remove the large peak resulting from the background. FIG. 1.2 shows the rescaled ICA-separated spectra of BPE and MPh (denoted as Y₁ and Y₂, respectively) as compared to the the real BPE and MPh spectra, s₁ and s₂. Qualitatively, the simulated ICA spectra captured the main characteristics of the pure BPE and MPh spectra. The cross-correlation coefficient R between the ICA-separated spectrum and the measured BPE spectrum was calculated to be R>0.9, while for MPh, R≈0.7. The result demonstrates that one can use the sampling induced composition gradient and ICA to obtain a good approximation of the pure analyte spectra from the mixture. After a close examination of FIG. 1.2, we find that negative peaks appear near Δν=810 and 1020 cm⁻¹ in the MPh spectra (FIG. 1.2B) which correspond strongly to intense BPE or background features; there is also a small negative peak near 400 and 1076 cm⁻¹ for the ICA spectra of BPE, which correspond to the intense MPh peaks at these locations.

Since the SERS spectra of the mixture are linear combinations of s₁ and s₂, the weighting coefficients in Eq. (1) should follow aᵢ₁ ∞ N_{BPE} and aᵢ₂ ∞ N_{MPh}, where N_{BPE} and N_{MPh} are the number of BPE and MPh molecules under the measurement area. Thus, fixing the location for the first measurement x₁ (i.e. the reference location) while varying the location of the second measurement x₂ (i.e. varying the analyte ratio within the laser spot) the corresponding weighting coefficient a₂₁ and a₂₂ can be calculated which should represent the ratio of BPE and MPh, respectively, at the location of x₂. As highlighted in FIG. 1.1B, the measurements obtained at P1 and P5 are significantly different, and therefore we have used both of them as x₁, and obtained the ratio of a₂₁/a₁₁ and a₂₂/a₁₂ as a function of different x₁ location. FIG. 1.3 shows the normalized ratio of the weighting coeffieients a₂ⱼ/a₁ⱼ, (normalized by the highest ratio value) for A) BPE and B) MPh. As a comparison, FIGS. 1.3A and 1.3B also show the peak intensities (black triangles) of BPE (Δν=1200 cm⁻¹) and MPh (Δν=1076 cm⁻¹), respectively, normalized to the highest intensity obtained for each analyte.

For FIG. 1.3A, the normalized a₂₁/a₁₁ ratio demonstrates a nearly perfect match to the normalized I₁₂₀₀ a₂₁/a₁₁, showing a fairly flat profile, with less than ˜50% drop in value at the right edge of the substrate, indicating that th BPE is evenly distributed onto the substrate. FIG. 1.3B on the other hand, shows that the I₁₀₇₆ is fairly uniform near the middle of the substrate, but the intensity drops by >90% and >60%, for the left and right edges points respectively. This indicates that the MPh surface coverage is significantly decreased closer to the edge of the substrate. The normalized a₂₂/a₁₂ ratio appears to match very closely to the normalized I₁₀₇₆ profile with respect to position on the substrate. It is also noted that the curve with P1 as a reference shows a better uniformity than the one with P5 as a reference, implying that two measurements separated further away followed better the assumption of statistical independency.

In conclusion we implemented ICA analysis with SERS measurements, which to the best of our knowledge, has yet to be reported. We show a novel, proof-of-principle application of ICA for SERS source signal separation of a mixture of probe molecules. Using the intrinsic, non-uniform, yet probe-dependent surface coverage distributions allows for a simple and elegant means to extract source signals.

References, each of which is incorporated herein by reference.
1. E. Blackie, E. C. Le Ru, M. Meyer, M. Timmer, B. Burkett, P. Northcote and P. G. Etchegoin, Physical Chemistry Chemical Physics, 2008, 10, 4147-4153.
2. P. G. Etchegoin, M. Meyer, E. Blackie and E. C. Le Ru, Analytical Chemistry, 2007, 79, 8411-8415.
3. E. Koglin, A. Tarazona, S. Kreisig and M. J. Schwuger, Colloids and Surfaces a-Physicochemical and Engineering Aspects, 1997, 123, 523-542.
4. R. Stevenson, R. J. Stokes, D. MacMillan, D. Armstrong, K. Faulds, R. Wadsworth, S. Kunuthur, C. J. Suckling and D. Graham, Analyst, 2009, 134, 1561-1564.
5. J. Thornton and R. K. Force, Applied Spectroscopy, 1991, 45, 1522-1526.
6. G. F. Wang, H. Y. Park and R. J. Lipert, Analytical Chemistry, 2009, 81, 9643-9650.
7. Q. Zhao, J. Langley, J. Lee, J. L. Abell and Y. Zhao, SPIE Defense, Security, and Sensing, 2011.
8. C. Gobinet, V. Vrabie, M. Manfait and O. Piot, Ieee Transactions on Biomedical Engineering, 2009, 56, 1371-1382.
9. X. G. Shao, Z. C. Liu and W. Cai, Analyst, 2009, 134, 2095-2099.
10. L. Silveira, A. R. De Paula, C. A. Pasqualucci and M. T. T. Pacheco, Instrumentation Science & Technology, 2008, 36, 134-145.
11. V. Vrabie, C. Gobinet, O. Piot, A. Tfayli, P. Bernard, R. Huez and M. Manfait, Biomedical Signal Processing and Control, 2007, 2, 40-50.
12. L. Fang, M. Lin and Y. Zheng, IEEE Computer Society Fourth International Conference on Natural Computation, 2008, 429-433.
13. S. B. Chaney, S. Shanmukh, R. A. Dluhy and Y. P. Zhao, Applied Physics Letters, 2005, 87.
14. J. D. Driskell, S. Shanmukh, Y. Liu, S. B. Chaney, X. J. Tang, Y. P. Zhao and R. A. Dluhy, Journal of Physical Chemistry C, 2008, 112, 895-901.
15. W. H. Yang, J. Hulteen, G. C. Schatz and R. P. VanDuyne, Journal of Chemical Physics, 1996, 104, 4313-4323.
16. H. M. Lee, M. S. Kim and K. Kim, Vibrational Spectroscopy, 1994, 6, 205-214.

### Example 2

### Brief Introduction:

By generating a composition gradient on a highly uniform SERS substrate and applying independent component analysis, we demonstrate that one can extract the intrinsic SERS spectrum of individual components from SERS spectra obtained from a two-component mixture.

### Discussion:

Surface-enhanced Raman scattering (SERS) has attracted a great deal of attention due to its powerful merits as an ultra-sensitive, label-free trace chemical sensing platform. The ability of SERS spectra to provide sharp, highly resolved spectral finger-prints allows for superior chemical and biological sensing.^{1, 2} Traditionally, SERS has been employed for analysis of relatively pure samples in a well defined medium; however, biologically-relevant samples, such as blood or sputum, contain a mixture of components, and the resulting SERS spectra can be very complicated compared to those of pure analytes. The conventional practice is to combine SERS with other separation techniques, such as microfluidic devices, dielectricphresis, etc [xxx], which always require the injection of fresh Ag or Au nanoparticles to form new SERS hot spots. Such a systematical way adds more complications for both device design and applications. Obtaining information about individual analyte(s) from SERS spectra of a mixture is a very challenging yet very urgent task for SERS community. So far, most reports in the literature use direct visual observation or statistical methods such as principal component analysis (PCA) to analyze SERS mixture signals.³⁻⁸ However, to obtain information of individual spectral components, higher order statistics, e.g. kurtosis beyond the 2^{nd} order Gaussian statistics is needed in a class of algorithms called blind source separation (BSS) method or independent component analysis (ICA).⁹ ICA is a statistical method that extracts individual source signals from the measured mixture signals by means of their joint density factorization. For example, if the measured signal results from a mixture of two analytes with source signal sᵢ (i=1, 2), the mixture signal xᵢ (i=1, 2), can be expressed as a linear combination of s₁ and s₂,

$${x}_{i} = {\sum }_{j }^{ } {a}_{ij} {s}_{ii} \qquad ( 1 )$$

where aᵢⱼ (i, j=1, 2) is constant, representing the weighting factor of a particular source signal. ICA de-mixes the signal xᵢ, decomposing the weight factors aᵢⱼ through Wiener whitening and orthogonal rotation. By applying ICA algorithm, the source signals sᵢ and the weighting factors aᵢⱼ can be determined from given measurements xᵢ under the assumption that the source signals are statistically independent, where the joint probability density function of the mixture signals is simply a product of marginal density functions of the source signals. ICA has been used to discriminate source signals from biological mixture signals for bulk Raman measurements,¹⁰⁻¹⁴ but to the best of our knowledge ICA has never been implemented with SERS. In order to perform ICA, at least two signals, x₁ and x₂, each containing a different mixture ratio, are obtained.

For real samples such as blood or sputum, the composition ratios of different analytes are typically fixed once the samples are received. Thus, it is a challenge to obtain two SERS spectra from samples with different compositions. One approach to address this challenge is to utilize the intrinsic, nonuniform distribution of analyte molecules that results when a liquid mixture is applied to a SERS-active surface. The resulting distribution of analytes onto the sensing surface can be significantly affected by the analytes' diffusivity and adsorption capability, as well as the drying process of the sample solvent. Because the measured SERS signal is proportional to the number of molecules within the measurement area, the resulting spatial distribution of each species onto the surface can be mapped by acquiring multiple measurements at different locations on the substrate. In this Communication, we utilize the intrinsic sampling-induced nonuniform distribution of two different analytes within a mixture sample, coupled with ICA, to demonstrate a proof-of-principle for unsupervised separation of SERS source spectra from measurements obtained from a mixture sample.

To demonstrate the principle, two Raman probes, trans-1,2-bis(4-pyridyl)ethylene (BPE) and 4-hydroxy thiophenol (i.e. mercaptophenol, MPh), are selected because they both produce strong yet distinct SERS spectra. Furthermore, BPE and MPh both adsorb strongly to Ag or Au surfaces but through different chemical constituents, i.e. a lone-pair nitrogen and a thiol, respectively, and therefore are expected to adsorb to the surface at different rates and with different binding strengths. Thus, applying a droplet containing a dilute mixture of these analytes to a SERS surface should simultaneously generate a non-uniform distribution of the two analytes with varying and spatially-dependent surface coverage ratios after the sample solvent dries as shown in FIG. 1.1A.

BPE and MPh were dissolved in methanol to yield 5×10⁻⁵ mol L⁻¹ solutions. A mixture of 1:1 BPE:MPh, with each analyte present at 5×10⁻⁵ mol L⁻¹ was also prepared. The SERS measurements were performed by dispensing a 4 μl volume of the mixture at the center of a small 1×1 cm² silver nanorod (AgNR) SERS substrates.^{15, 16} The droplet immediately spread across the entire surface of the AgNR substrate and the methanol completely evaporated in ˜1 min. SERS spectra were obtained using a portable Raman system (Enwave Optronics, model 10HT-HRC) with a λ=785 nm laser, at 30 mW power and 2 s integration time. Approximately 9 measurements were mapped along a line across the substrate using ˜1 mm steps as shown in FIG. 1.1A.

FIG. 1.1B shows the SERS spectra of pure BPE, MPh, the 1:1 BPE:MPh mixture acquired from an average of 9 points measured in a grid-like pattern across the 1×1 cm² AgNR substrates. The figure also includes a representative spectrum of the MeOH as well as an artificial spectrum generated by summing the pure MPh and pure BPE spectra together. The measured BPE signal (used as s₁) demonstrates sixteen observable peaks at Δν=254, 691, 811, 888, 969, 1016, 1068, 1203, 1231, 1245, 1277, 1344, 1430, 1495, 1546, 1611, and 1640 cm⁻¹ with the primary BPE peaks being Δν=1016, 1203, 1611, and 1640 cm⁻¹, which correspond to the pyridine ring breathing, C═C ethylene stretch, C═C pyridine stretch, and C═C ethylene stretch, respectively.¹⁷ Fifteen peaks are distinguishable in the measured MPh spectrum (used as s₂), Δν≈273, 330, 400, 582, 649, 704, 820, 996, 1076, 1115, 1169, 1250, 1342, 1482, and 1555 cm⁻¹. Of these, the primary peaks observed for MPh are Δν=400, 1076, and 1169 cm⁻¹, which corresponds to ring vibrations of the benzene constituent.¹⁸ BPE and MPh therefore appear to have fairly distinct spectra, with the only significantly overlapping peaks at Δν=996 and 1016 cm⁻¹, respectively. Furthermore, comparing these spectra to those acquired from the control sample (methanol only) we can see the large, defined peaks at Δν=˜270 and ˜800 cm⁻¹ common in all the spectra which likely result from adsorbed contaminants. The measured spectrum of the BPE:MPh mixture is virtually identical to the artificial spectrum generated by adding the SERS spectra of pure BPE and pure MPh together, confirming that a mixture spectrum is a linear combination of the individual SERS spectra of the two probes. Finally, the spectral cross-correlation coefficient r of the BPE and MPh are quantitatively estimated as r=−0.005, which demonstrates the independence of SERS spectra of the two source analytes. Thus, we can apply ICA algorithm to the SERS spectra of this mixture.

Also, a large variation in SERS spectra at different locations of the mixture was obtained for MPh, indicating a non-homogenous distribution of the analyte onto the surface. The spectra of the BPE:MPh mixture acquired near the center (xP5) and near the edge (x_{P1}) of the substrate are also presented in FIG. 1.1B. Cursory examination of these spectra show that the BPE peak intensity is relatively insensitive to position, indicating a uniform BPE surface coverage across the SERS substrate; meanwhile the MPh peak intensities at Δν=400, 1076, 1169, and 1555 cm⁻¹ decrease significantly as the measurement position approaches the edge of the substrate. This indicates that the surface coverage of MPh decreases from center to edge, implying that there is a spatial gradient of the BPE and MPh on the substrate surface. This result is expected due to the capillary spreading of the droplet and the interfactial interaction nature of BPE and MPh. The MPh appears to adsorb to the Ag surface with a much faster rate compared to that of BPE, and because there is only a limited amount of each analyte in the solution, the MPh molecules in solution will be depleted before the wetting front reaches the edge of the substrate. However, because BPE may be adsorbing more slowly on the AgNR, there will still be sufficient BPE molecules to access (and adsorb to) the AgNRs near the wetting front before being depleted. Therefore, a gradient of MPh and BPE coverage from the center to the edge will be established as shown in FIG. 1.1A. Such spatial variation of the analyte intensity ratio is key to demonstrate the principle of separation in this work. Finally, the spectral features resulting from the background show very little variation.

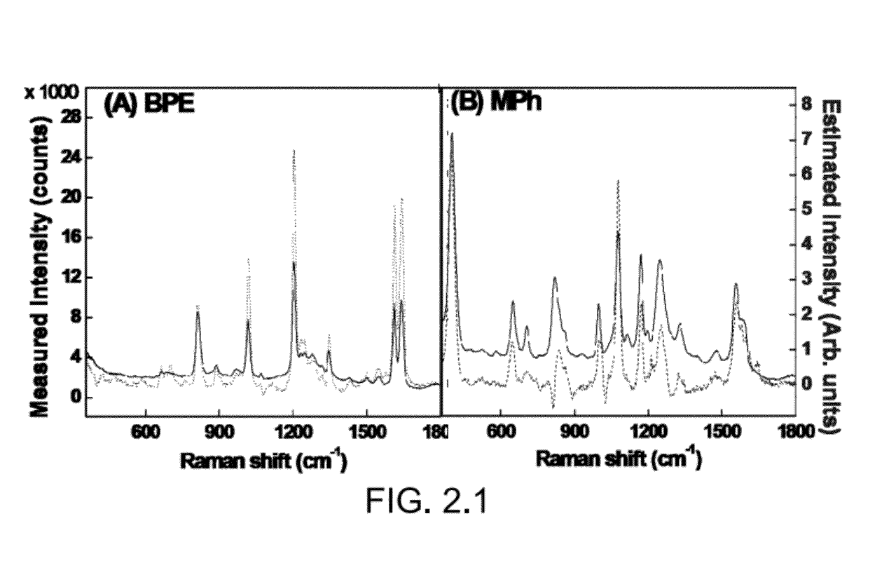

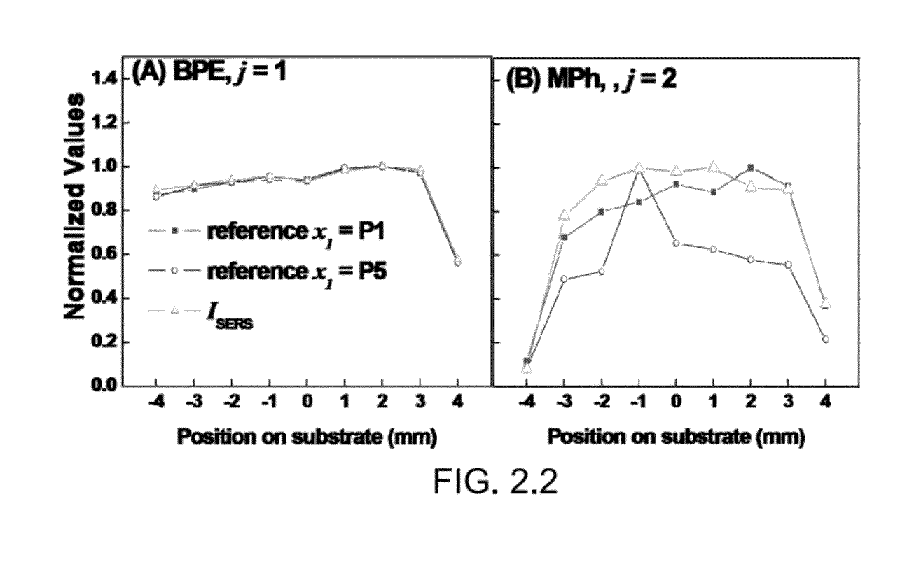

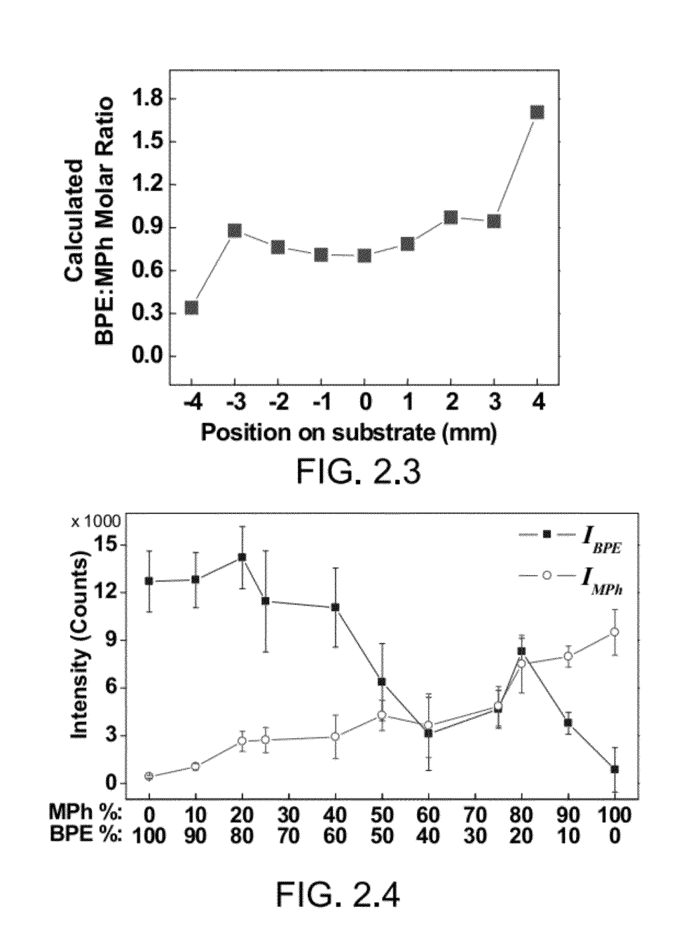

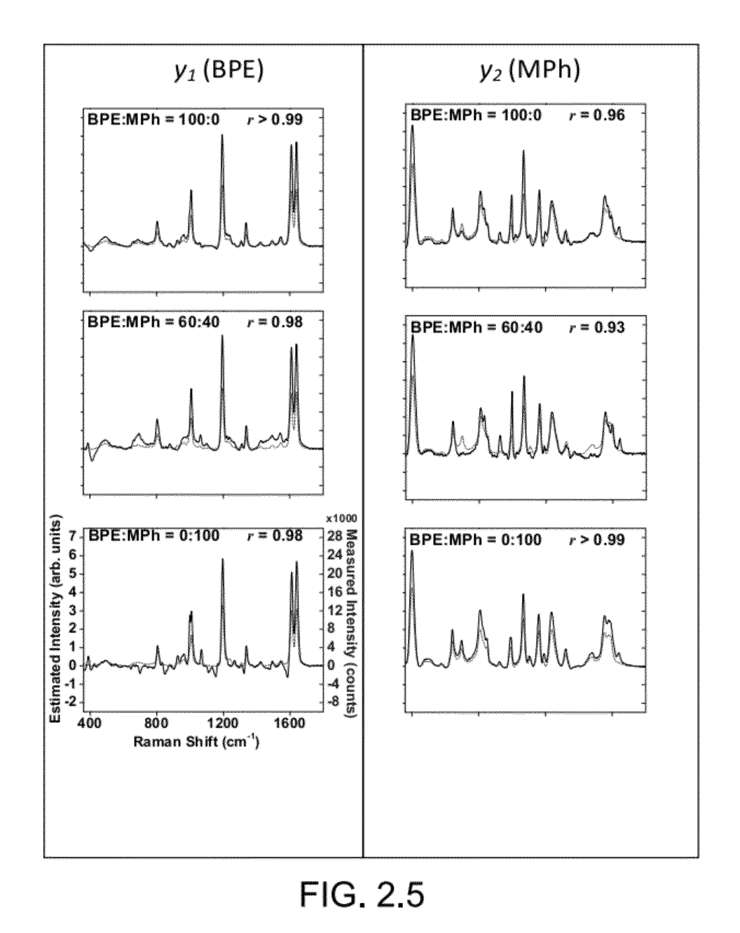

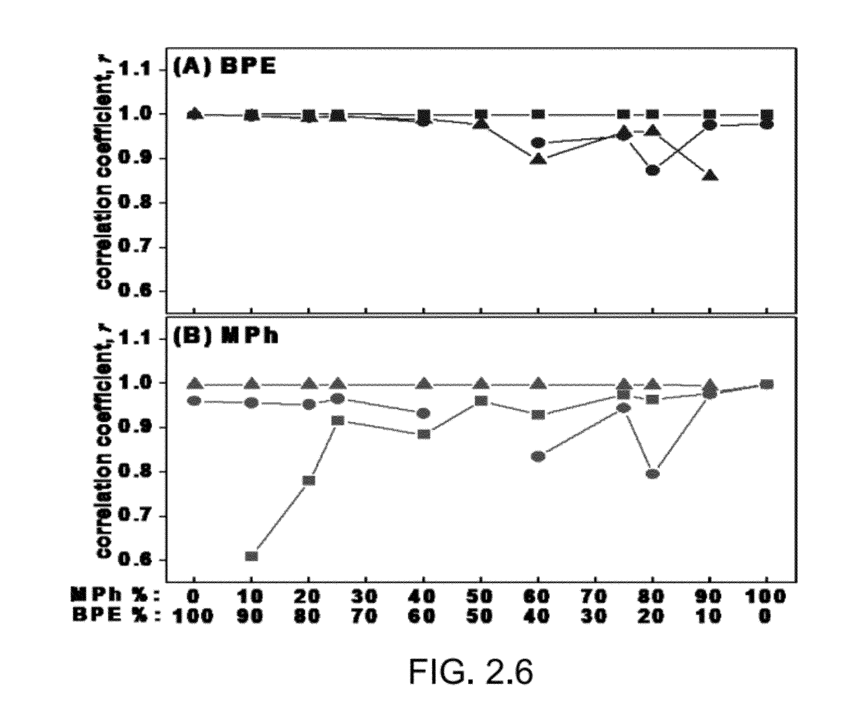

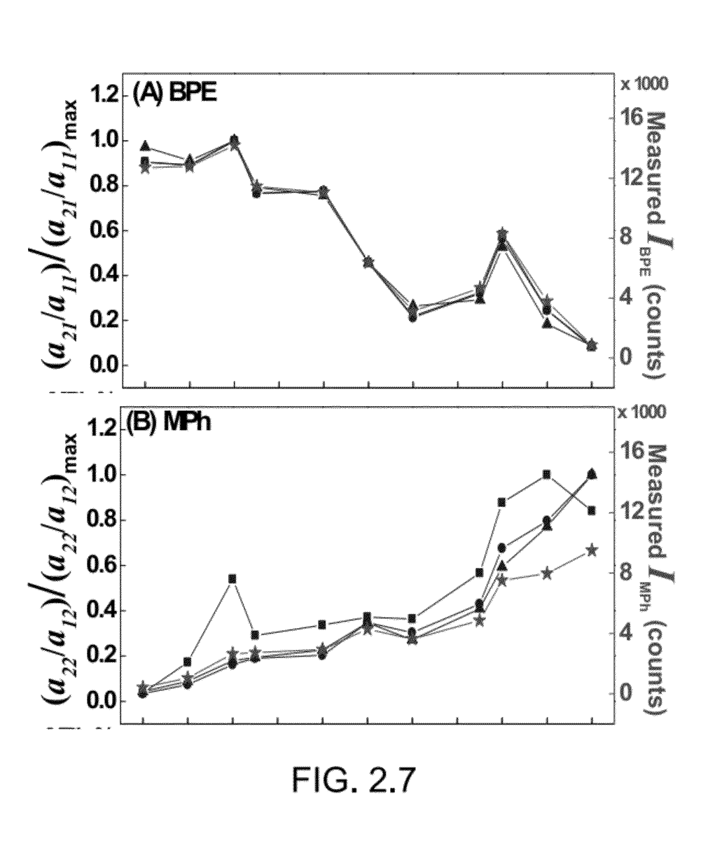

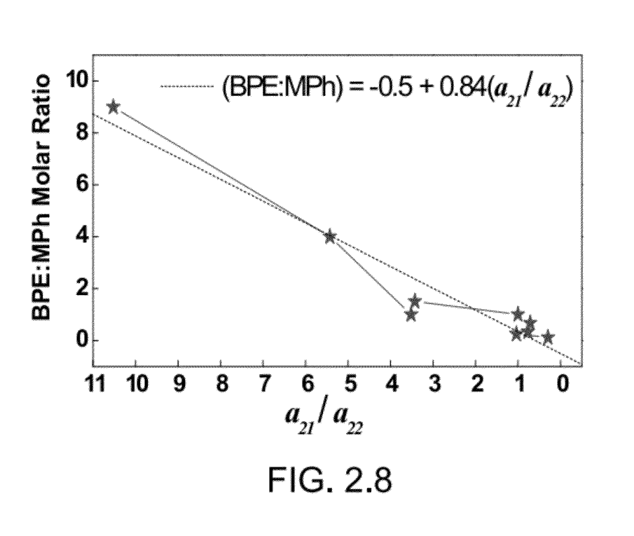

Multiple SERS spectra acquisitions (9 positions, P1 through P9, along 3 rows on the substrate surface, as shown in FIG.1.1(a)) were performed. Various combination of the SERS data, e.g. , x_{P1} and x_{P2} , x_{P1} and x_{P3}, . . . , x_{P1} and x_{P9,} or x_{P5} and x_{P6}, x_{P5} and x_{P9} were used as the mixture signals x₁ and x₂ to perform ICA analysis shown in FIG. 2.1, where x_{P1} and x_{P5} were used as one of the two measurements in order to check the spatial dependency of data acquisition on the substrate surface. We performed processing steps, including detrending, centering and whitening of the mixture signals as a preprocessing technique to make the ICA estimation simpler and better conditioned. First, the baselines of the all data were removed. The removal procedure estimates the baseline through multiple windows followed by regressing the baseline to the estimates with a spline approximation. Next, we performed the centering process by subtracting its mean value from the original mixture signals so that the mixture signals and the independent components have zero mean. Then, we performed the whitening process so that the source signals are uncorrelated and their variances equal unity.

In this Example, we have performed ICA by maximization of non-Gaussianity. According to the central limit theorem, a sum of two independent random variables (i.e. source signals) usually has a distribution that is closer to Gaussian than any of the two original random variables. To use non-Gaussianity for the ICA estimation, we need a quantitative measurement such as the kurtosis, entropy, or negentropy. In this work, we have employed FastICA which uses a fixed point algorithm and the negentropy as a quantitative measurement for the non-Gaussianity to estimate the original spectra.⁸ To improve the accuracy of the estimated ICA spectra, the measured spectra were truncated below 360 cm⁻¹ to remove the large peak resulting from the background. FIG. 2.1 shows the rescaled ICA-separated spectra of BPE and MPh compared to the measured spectra. Qualitatively, the simulated ICA spectra capture the main characteristics of the pure BPE and MPh spectra. The cross-correlation coefficient r between the ICA-separated spectrum and the measured BPE spectrum was calculated to be r>0.9, while for MPh, r≈0.7. The result demonstrates that one can use the sampling induced composition gradient and ICA to obtain a good approximation of the pure analyte spectra from the mixture. After a close examination of FIG. 2.1, we find that negative peaks appear near Δν=810 and 1020 cm⁻¹ in the calculated MPh spectra (FIG. 2.1B) which appear to correspond to the intense BPE or background features; there is also a small inverted peak near 400 and negative peak at 1076 cm⁻¹ for the ICA spectra of BPE, which correspond to the intense MPh peaks at these locations.

Since the SERS spectra of the mixture are linear combinations of s₁ and s₂, the weighting coefficients in Eq. (1) should follow aᵢ₁ ∞ N_{BPE} and aᵢ₂ ∞ N_{MPh}, respectively, where N_{BPE} and N_{MPh} are the number of BPE and MPh molecules within the measurement area. Thus, by fixing x₁ as the spectrum at a specific location (i.e. the weighting coefficients a₁₁ and a₁₂ are fixed) while varying x₂ with the spectrum from different locations, the location-dependent weighting coefficients a₂₁ and a₂₂ can be estimated. These two coefficients a₂₁ and a₂₂ can be used to represent the coverge ratio of BPE and MPh at different locations. As highlighted in FIG. 1.1B, the measured SERS spectra at P1 and P5 are significantly different, we have used either of them as the reference measurement x₁, and obtained the ratio of a₂₁/₁₁ and a₂₂/a₁₂ as a function of different locations. FIG. 2.2 shows the normalized ratio of the weighting coeffieients a₂ⱼ/a₁ⱼ, (normalized to the maximum ratio value) for A) BPE and B) MPh using P1 (squares) or P5 (circles) as a reference point. As a comparison, FIGS. 2.2A and B also show the peak intensities (triangles) of BPE (Δν=1200 cm⁻¹; I₁₂₀₀) and MPh (Δν=1076 cm⁻¹; I₁₀₇₆), respectively, which were also normalized to the maximum intensity obtained for each analyte. Because ICA does not generate weighting coefficients for the reference location, the ratio a₂ⱼ/aᵢⱼ was artificially set equal to unity at these locations for visualization purposes.

As shown in FIG. 2.2A, the spatially-dependent normalized a₂₁/a₁₁ ratio demonstrates a nearly perfect match to the spatially-dependent normalized I₁₂₀₀, regardless the reference locations. Both I₁₂₀₀ and the ratio a₂₁/a₁₁ show a fairly flat spatial dependence, with less than ˜50% drop in value at the right edge of the substrate, indicating that the BPE is evenly distributed onto the AgNR substrate. FIG. 2.2B, on the other hand, shows that the I₁₀₇₆ drops by >90% and >60%, for the left and right edge points respectively. This indicates that the MPh surface coverage is significantly decreased closer to the edge of the substrate. The normalized a₂₂/a₁₂ ratio in FIG. 2.2B appears to match very closely to the normalized I₁₀₇₆ profile with respect to position on the substrate. We also point out that the plot with P1 as a reference shows a better match to the I₁₀₇₆ profile than the one with P5 as a reference. This result demonstrates that ICA can be used to quantitatively map the analyte distribution.

Since the coefficients a₂₁ and a₂₂ are proportional to the number of particular molecules measured, the ratio a₂₁/a₂₂ should be proportional to the BPE:MPh ratio at a specific location, i.e., in principle one can map the BPE:MPh ratio at different locations from FIG. 2.2. To do so, we first need to establish a calibration curve of a₂₁/a₂₂ versus BPE:MPh ratio. Mixture solutions with fixed BPE:MPh ratios were prepared and applied to different substrates and average SERS spectra was determined for each ratio (See Supplementary Materials for details). Again, FastICA was used to generate aᵢⱼ for each mixture relative to the reference. FIG. 2.8 shows the calibration curve of a₂₁/a₂₂ versus BPE:MPh. Therefore, the BPE:MPh ratio map in our experiment can be obtained as shown in FIG. 2.3. For comparison, use the SERS peak ratio of BPE and MPh, we can obtain another ratio mapping through the calibration curve FIG. 2.8. This result demonstrates that the ICA plus composition gradient can be used to predict the mixture's composition ratio.

In conclusion, we have successfully implemented ICA analysis to seperate the intrinsic SERS spectra of the components in a mixture by obtaining a spatially distributed SERS spectra of a single mixture. The weighing coefficients obtained from the ICA analysis can be used to quantitatively map the spatial distribution of each component. This proof-of-principle demonstrates that one can potentially separate mixture SERS spectra using only one mixture sample. However, for practical clinic samples, this technique needs further refinement due to the constraints of ICA, especially the requirement for spectral independence of the analytes of interest. Many biomolecules of interest such as proteins are composed of similar molecular constituents, i.e. the same 20 amino acids, and therefore may not show significant signal independence ultimately disqualifying them for ICA analysis. Smaller biologically relevant molecules, however, have been investigated with SERS and may demonstrate the requisite signal independence. Thus, to further improve ICA for correlated signal analysis is needed. Furthermore, traditional approaches for multiplexing analysis (e.g. fluorescent labeling) can also be utilized for SERS and ICA analysis. For example, one can use an extrinsic-label SERS multiplexing approach, labeling the analytes with pre-selected molecules that show spectral independence. In this case, the current ICA method should be well suited to separate the source signals of the labels from complex mixture spectra.

References, each of which is incorporated herein by reference:
1. K. Hering, D. Cialla, K. Ackermann, T. Dorfer, R. Moller, H. Schneidewind, R. Mattheis, W. Fritzsche, P. Rosch and J. Popp, Anal. Bioanal. Chem., 2008, 390, 113-124.
2. S. D. Hudson and G. Chumanov, Anal. Bioanal. Chem, 2009, 394, 679-686.
3. E. Blackie, E. C. Le Ru, M. Meyer, M. Timmer, B. Burkett, P. Northcote and P. G. Etchegoin, Phys. Chem. Chem. Phys., 2008, 10, 4147-4153.
4. P. G. Etchegoin, M. Meyer, E. Blackie and E. C. Le Ru, Anal. Chem., 2007, 79, 8411-8415.
5. E. Koglin, A. Tarazona, S. Kreisig and M. J. Schwuger, Colloids Surf., A, 1997, 123, 523-542.
6. R. Stevenson, R. J. Stokes, D. MacMillan, D. Armstrong, K. Faulds, R. Wadsworth, S. Kunuthur, C. J. Suckling and D. Graham, Analyst, 2009, 134, 1561-1564.
7. J. Thornton and R. K. Force, Appl. Spectrosc., 1991, 45, 1522-1526.
8. G. F. Wang, H. Y. Park and R. J. Lipert, Anal. Chem., 2009, 81, 9643-9650.
9. Q. Zhao, J. Langley, J. Lee, J. L. Abell and Y. Zhao, SPIE Defense, Security, and Sensing, 2011.
10. C. Gobinet, V. Vrabie, M. Manfait and O. Piot, IEEE Trans. Biomed. Eng., 2009, 56, 1371-1382.
11. X. G. Shao, Z. C. Liu and W. Cai, Analyst, 2009, 134, 2095-2099.
12. L. Silveira, A. R. De Paula, C. A. Pasqualucci and M. T. T. Pacheco, Instrum Sci. Technol., 2008, 36, 134-145.
13. V. Vrabie, C. Gobinet, O. Piot, A. Tfayli, P. Bernard, R. Huez and M. Manfait, Biomed. Signal Process. Control, 2007, 2, 40-50.
14. L. Fang, M. Lin and Y. Zheng, IEEE Computer Society Fourth International Conference on Natural Computation, 2008, 429-433.
15. S. B. Chaney, S. Shanmukh, R. A. Dluhy and Y. P. Zhao, Appl. Phys. Lett., 2005, 87.
16. J. D. Driskell, S. Shanmukh, Y. Liu, S. B. Chaney, X. J. Tang, Y. P. Zhao and R. A. Dluhy, J. Phys. Chem. C, 2008, 112, 895-901.
17. W. H. Yang, J. Hulteen, G. C. Schatz and R. P. VanDuyne, J. Chem. Phys., 1996, 104, 4313-4323.
18. H. M. Lee, M. S. Kim and K. Kim, Vib. Spectrosc., 1994, 6, 205-214.

### Supplementary Material for Example 2

Various mixtures of BPE and MPh were prepared and 4 μl of each mixture was applied to a separate substrate. After the solvent had dried multiple points (n=15) were measured on each substrate using the same measurement conditions previously outlined in this report. The average spectra for each mixture-treated substrate is determined and used to ascertain the individual BPE and MPh component spectra y₁ and y₂, respectively. Several different reference samples were used, BPE:MPh=100:0, 50:50, or 0:100, as x₁. Each reference was then compared to each of the 10 other mixtures (x₂) to generate y₁ and y₂. The estimated y₁ and y₂ spectra were then compared to the s₁ and s₂ (i.e. 100:0 and 0:100 BPE:MPh, respectively) and representative results are demonstrated in FIGS. 2.5A and 2.5B for BPE and MPh, respectively.

For most of the estimated spectra we can see a very high degree of similarity between the estimated y1 spectra and the pure analyte signal. The high degree of cross correlation r obtained for y₁ and y₂ with s₁ and s₂, respectively, quantitatively demonstrate very robust and accurate separation of the component signals. A plot of the r values as a function of BPE:MPh using three different reference samples is shown in FIG. 2.6. These plots show that the pure BPE and pure MPh are the best references to use to obtain the most accurate BPE and MPh component signals, respectively. Incidentally, using these pure samples as references yields the worst component spectra when determining the source signal of the opposite analyte when it is present at lower concentrations. Using the 50:50 BPE:MPh sample as a reference appears to work sufficiently well for both analytes at all concentrations.

Because the weighting coefficient aᵢⱼ represents a (relative) quantitative measure of the component signal, we compared this value to the measured intensity of the source signal xᵢ. FIG. 2.7A shows the normalized ratios of the calculated mixing coefficient. For each mixture, the BPE weighting coefficient a₂₁ was calculated and then divided by the reference weighting coefficient a₁₁. Just as with the spatial mapping data in FIG. 2.2, all a₂₁/a₁₁ ratios for a given reference were divided by the maximum a₂₁/a₁₁ value of that reference set to make the data more comparable. These normalized values are then compared to the measured I_{BPE}. Because ICA does not generate weighting coefficients for the reference sample we point out that we artificially set a₂₁/a₁₁=1 for the reference sample, just as with FIG. 2.2. We also note that occasionally FastICA generates negative weighting coefficients, which is likely resulting from noise; however, simply taking the absolute value of the estimated aᵢⱼ appears to mitigate the issue.

Based on FIG. 2.7A, ICA clearly demonstrates an accurate and precise method for quantitatively determining the relative contribution of the BPE component signal from a mixture. Furthermore, regardless of which reference sample is used (x₁=100:0, 0:100, or 50:50 BPE:MPh), the results correspond very closely with the measured intensity. FIG. 2.7B shows the same treatment for MPh (i.e., a₂₂/a₁₂) as in part (A). We point out that the MPh weighting coefficient ratio appears to deviate slightly more from the measured I_{MPh} compared to BPE, but still follows the same overall trend of the I_{MPh}. This is similar to FIG. 2.2B which also demonstrates some deviation of a₂₂/a₁₂ from the measured intensity, but the exact cause for this discrepancy between the accuracy of the BPE and MPh is still unclear.

Using the estimated weighting coefficients used in FIG. 2.7 we can construct a calibration curve to relate the ratio of the BPE and MPh weighting coefficients a₂₁ and a₂₂, respectively, to their molar ratio for a given measurement location from FIG. 2.2. To do this, the a₂₁/a₂₂ ratio (using values estimated with 50:50 BPE:MPh reference) were plotted versus the molar ratio. The result is shown if FIG. 2.7, and we can see that the resulting plot is roughly linear. Due to the fact that a₂₁/a₂₂ is not perfectly monotonic with respect to the BPE:MPh ratio the calibration plot shows some inconstancies (i.e. doubling back on itself) when a₂₁/a₂₂ becomes small. Regardless, a suitable linear fit is achievable which is displayed with its equation in FIG. 2.8. To relate the ratio of the weighting coefficient to the molar ratio, the a21/a22 values from FIGS. 2.2A and 2.2B were input into this equation, yielding a BPE:MPh molar ratio for each location, which is plotted in FIG. 2.7.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim:

1. A method of analyzing a SERS signal, comprising:
acquiring SERS data from a sample,
performing an independent component analysis on the SERS data, and
determining one or more analytes present in the sample.

2. The method of claim 1, further comprising:
disposing the sample on a SERS structure and generating a composition gradient.

3. The method of claim 2, wherein acquiring SERS data from the sample includes:
acquiring SERS data from multiple distinct areas of the SERS structure.

4. The method of claim 3, wherein performing the independent component analysis on the SERS data comprises:
comparing the SERS data obtained from the multiple distinct areas of the SERS structure.

5. The method of claim 4, further comprising:
determining the ratio of one or more pairs of analysts at each of the multiple distinct areas.

6. A method of analyzing a SERS signal, comprising:
disposing the sample on a SERS structure and generating a composition gradient along the x-axis, the y-axis, the diagonal axis, or a combination thereof,
acquiring SERS data from a plurality of positions of the composition gradient, and
determining the ratio of one or more pairs of analysts at each of the multiple distinct areas.

7. The method of claim 6, further comprising: determining one or more analytes present in the sample.

8. The method of claim 6, further comprising: performing an independent component analysis on the SERS data acquired from the plurality of positions along the composition gradient.

9. A method of analyzing a SERS signal, comprising:
disposing the sample on a SERS structure and generating a composition gradient along the x-axis, the y-axis, the diagonal axis, or a combination thereof,
acquiring SERS data from a plurality of positions of the composition gradient,
performing an independent component analysis on the SERS data acquired from the plurality of positions along the composition gradient,
comparing the SERS data obtained from the multiple distinct areas of the SERS structure, and
determining the ratio of one or more pairs of analysts at each of the multiple distinct areas.
